(19) United States
(12) Patent Application Publication
(10) Pub. No.: US 2022/0197445 A1
(43) Pub. Date: Jun. 23, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Takanori ONO, Yokohama-shi (JP)

(73) Assignee: FUJIFILM Business Innovation Corp., Tokyo (JP)

(21) Appl. No.: 17/332,707

(22) Filed: May 27, 2021

(30) Foreign Application Priority Data
Dec. 23, 2020 (JP) 2020-214207

(51) Int. Cl. G06F 3/0482; G06F 3/0484

(52) U.S. Cl. CPC G06F 3/0482; G06K 9/00449; G06F 3/0484

(57) ABSTRACT

An information processing apparatus includes a processor configured to display data in forms to be processed, switchably in one of a first mode, in which the data in the forms are displayed for each type of the forms, and a second mode, in which the data in the forms are displayed for each processing unit by which the data in the forms are to be processed.

### CROSS-REFERENCE TO RELATED APPLICATIONS

This application is based on and claims priority under 35 USC 119 from Japanese Patent Application No. 2020-214207 filed Dec. 23, 2020.

### BACKGROUND

### (i) Technical Field

The present disclosure relates to an information processing apparatus and a non-transitory computer readable medium.

### (ii) Related Art

Japanese Patent No. 5682833 discloses a job management application that operates on a device that manages jobs for an image forming apparatus, the job management application causing the device to execute: an information acquisition process for acquiring information about job data stored in a storage section of the image forming apparatus; a graph generation process for generating a graph indicating the capacity used by the storage section for each job type on the basis of the information about the job data; a list generation process for generating, for each job, a list describing job contents including the job type on the basis of the information about the job data; and a screen control process for displaying the graph and the list on the same job management screen and, in the case where an operation of deleting one or more jobs from the list is performed, updating the display of the used capacity on the graph corresponding to the job type to which the deleted jobs belong.

Japanese Patent No. 6413793 discloses an information processing apparatus including: a transmission section that transmits scan instruction information to a scanner that has an operation display section; a receiving section that receives scan data of a form scanned by the scanner; an image analysis section that performs image analysis on the received scan data; a data registration section that registers the received scan data in a first database; and a display control information generation section that generates display control information for displaying analysis information corresponding to a result of the image analysis and a registration state of the received scan data registered in the first database, the transmission section transmitting the generated display control information to the scanner.

Japanese Unexamined Patent Application Publication No. 2003-316545 discloses an information processing method of managing the status of a plurality of printers, the method including: specifying a plurality of printers registered; acquiring the status of jobs associated with the plurality of printers specified in the specifying; and displaying a list of the status of the jobs associated with the plurality of printers acquired in the acquiring.

Japanese Unexamined Patent Application Publication No. 2006-209261 discloses a method of displaying jobs in a received form, the method including: receiving an electronic image; recognizing the type of a form from the received electronic image; determining whether the recognized electronic image is a form registered in advance or an unrecognizable form; setting a method of displaying the unrecognizable form in advance; and displaying a list of the determined form in accordance with the set display method.

### SUMMARY

When a user inputs data in forms, a plurality of forms are occasionally input collectively. To confirm the input data on such occasions, it is desirable to confirm the data for each type of the forms in some cases, and it is desirable to confirm the data for each processing unit by which the data should be processed in other cases.

Aspects of non-limiting embodiments of the present disclosure relate to providing an information processing apparatus and a non-transitory computer readable medium capable of switching between a mode in which data in forms to be processed are displayed for each type of the forms and a mode in which the data in the forms are displayed for each processing unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to display data in forms to be processed, switchably in one of a first mode, in which the data in the forms are displayed for each type of the forms, and a second mode, in which the data in the forms are displayed for each processing unit by which the data in the forms are to be processed.

### BRIEF DESCRIPTION OF THE DRAWINGS

An exemplary embodiment of the present disclosure will be described in detail based on the following figures, wherein:

FIG. 1 illustrates a schematic configuration of a form system according to the present exemplary embodiment;

FIG. 2 illustrates definitions and rules of processes for forms A;

FIG. 3 illustrates definitions and rules of processes for the forms A and forms B;

FIG. 4 illustrates an example of output display of the form system according to the present exemplary embodiment;

FIG. 5 is a block diagram illustrating the hardware configuration of an information processing apparatus according to the present exemplary embodiment;

FIG. 6 is a block diagram illustrating the functional configuration of the information processing apparatus;

FIG. 7 illustrates a display example of a first mode screen that displays data in forms to be processed for each type of the forms;

FIG. 8 illustrates a display example of a second mode screen that displays data in forms for each processing unit;

FIG. 9 illustrates another display example of the second mode screen that displays data in forms to be processed for each processing unit;

FIG. 10 illustrates the relationship among forms, job rules, job rule sets, and jobs; and

FIG. 11 is a flowchart illustrating a process performed by the information processing apparatus according to the present exemplary embodiment.

### DETAILED DESCRIPTION

An exemplary embodiment of the present disclosure will be described in detail below with reference to the drawings.

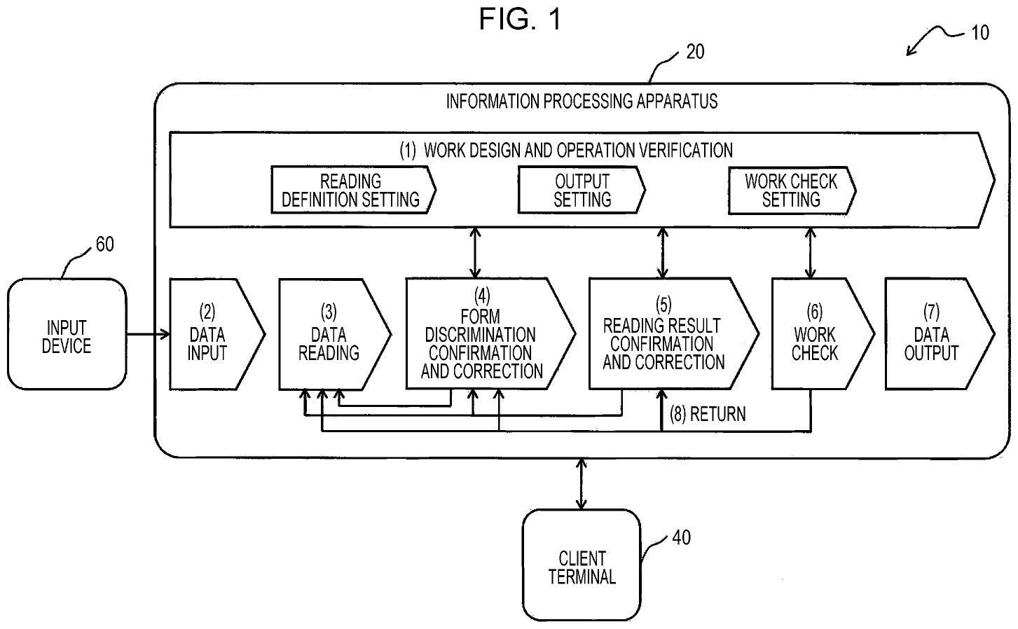

FIG. 1 illustrates a schematic configuration of a form system 10 according to the present exemplary embodiment.

As illustrated in FIG. 1, the form system 10 includes an information processing apparatus 20, a client terminal 40, and an input device 60. These devices are connected to a network (not illustrated), and communicable with each other via the network. The network may be the Internet, a Local Area Network (LAN), a Wide Area Network (WAN), etc., by way of example.

The information processing apparatus 20 performs an optical character recognition (OCR) process on image data on a plurality of documents including forms input through the input device 60, and manages the flow of a sequence of processes for outputting the result of the OCR process to an output destination determined in advance. The specific configuration and function of the information processing apparatus 20 will be discussed later.

The client terminal 40 transmits various instructions related to the OCR process to the information processing apparatus 20. The various instructions include an instruction to start reading of information in the image data, an instruction to display the result of reading of information in the image data, etc., by way of example. In addition, the client terminal 40 displays various types of information such as the result of the OCR process performed by the information processing apparatus 20, notifications related to the OCR process, etc., in accordance with the received various instructions. The client terminal 40 may be a general-purpose computer device such as a server computer and a personal computer (PC), by way of example. In FIG. 1, only one client terminal 40 is illustrated. However, the present disclosure is not limited thereto, and a plurality of client terminals 40 may be prepared and used for different processes, by way of example.

The input device 60 inputs image data to be subjected to the OCR process to the information processing apparatus 20. The input device 60 may be a general-purpose computer device such as a server computer and a PC, or an image forming apparatus that has a scan function, a printer function, a facsimile function, etc., by way of example. Not only the input device 60 but also the client terminal 40 may be able to input image data to the information processing apparatus 20.

Next, an overview of the form system 10 will be described.

In the form system 10, the information processing apparatus 20 performs an OCR process on image data input through the input device 60, and outputs the result of the OCR process to an output destination determined in advance.

In the OCR process, the information processing apparatus 20 manages various processes including (1) work design and operation verification, (2) data input, (3) data reading, (4) form discrimination confirmation and correction, (5) reading result confirmation and correction, (6) work check, (7) data output, and (8) return. In the present exemplary embodiment, the OCR process includes not only simple processes of reading characters, symbols, etc. from image data, but also post-processing such as correction of the characters.

In an example of management of the various processes, processes including (1) work design and operation verification, (2) data input, (3) data reading, (6) work check, and (7) data output are automatically executed by the information processing apparatus 20. In an example of management of the various processes, processes including (4) form discrimination confirmation and correction and (5) reading result confirmation and correction are input by the user through the client terminal 40 to be received. In an example of management of the various processes, the process of (8) return is occasionally automatically executed by the information processing apparatus 20, and occasionally input by a user through the client terminal 40 to be received.

In the process of (1) work design and operation verification, job rules including reading definition setting, output setting, and work check setting are prepared. In the reading definition setting, by way of example, a reading range in which information in image data is read in the process of “(3) data reading” is set. More specifically, by way of example, definition such as reading an item value as a value from around the right side of an item extracted as a key may be set. In the output setting, by way of example, the file format and the output destination of output data to be output in the process of “(7) data output” are set. In the work check setting, by way of example, the item required to be input to the form to be detected, the format such as the number of characters that may be input, etc. in the process of “(6) work check” are set.

In the process of (2) data input, input of image data from the input device 60 is received. The image data, input of which has been received, are registered as a job which is the unit of execution of the process of “(3) data reading”.

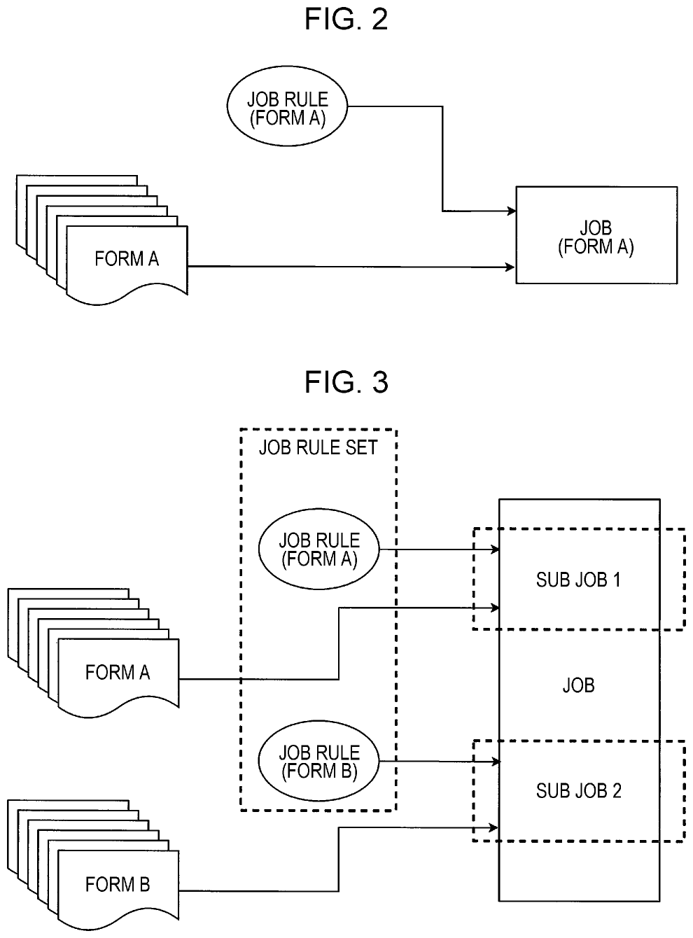

In the process of (3) data reading, information in image data in a job to be executed is read using a job rule for the job selected by the user from among the job rules prepared in the process of “(1) work design and operation verification”. In this process, by way of example, discrimination (hereinafter referred to as “form discrimination”) of a form included in the image data in the job and reading of characters and symbols within the reading range are performed. It is not necessary that a single job rule is selected by the user for one job. In the case where a plurality of job rules are selected for one job, the image data are processed using a set including the plurality of job rules, that is, a job rule set. In this case, a job rule for the determined type, among the plurality of job rules, is applied to each form indicated in the image data in accordance with the result of a type discrimination. Hereinafter, processes defined by job rules in the case where processing is performed using a job rule set will be referred to as “sub jobs”. The job rules, the job rule set, and the sub jobs will be discussed in detail later with reference to FIGS. 2 and 3.

In the process of (4) form discrimination confirmation and correction, image data in a job are divided into records that indicate a form included in the job on the basis of the result of the form discrimination performed in the process of “(3) data reading”. After that, in this process, the records that result from the dividing are displayed, and a confirmation and a correction of the form discrimination by the user are received.

In the process of (5) reading result confirmation and correction, the result of the reading of characters and symbols within the reading range performed in the process of “(3) data reading” is displayed, and a confirmation and a correction of the result of reading by the user are received.

In the process of (6) work check, an error in the foregoing processes is detected using work check setting included in the job rule for the job selected by the user from among the job rules prepared in the process of “(1) work design and operation verification”. The detection result may be presented to the user.

In the process of (7) data output, output data are prepared using output setting included in the job rule for the job selected by the user from among the job rules prepared in the process of “(1) work design and operation verification”, and the prepared output data are output to an output destination determined in advance.

In the process of (8) return, the process is returned from a process executed in the OCR process to a process one or a plurality of stages earlier. An instruction to return is provided by the user from the client terminal 40 during execution of various processes such as “(4) form discrimination confirmation and correction” and “(5) reading result confirmation and correction”, by way of example. Alternatively, an instruction to return is provided from the client terminal 40 of a manager in accordance with the result of a check performed by the manager between the processes of “(6) work check” and “(7) data output”, by way of example.

In the OCR process described above, the process of “(1) work design and operation verification” is executed before the process of “(3) data reading” and the subsequent processes are performed, that is, before operation of the form system 10. Further, the process of “(1) work design and operation verification” may be executed during operation of the form system 10 while the process of “(3) data reading” and the subsequent processes are being performed. By way of example, the job rule prepared in the process of “(1) work design and operation verification” before operation of the form system 10 may be corrected, as appropriate, in accordance with the result of the process of “(5) reading result confirmation and correction” during operation of the form system 10.

Next, the job rules, the job rule set, and the sub jobs will be described with reference to FIGS. 2 and 3.

The job rules are definitions for discriminating and identifying the type of target forms, rules related to correction of data as the discrimination result and detection of an error at the time when such an error occurs, definitions of output setting, etc., for example. The rules related to detection of an error refer to confirmation of the consistency in the amount of money etc. The definitions of output setting refer to setting of the output format and setting of the output destination. The job rule in the example illustrated in FIG. 2 refers to definitions and rules of processes for forms A which are of a type A. Each job rule is used to process forms of one type. As illustrated in FIG. 2, a job is configured to include data in the forms A to be processed and the job rule for the forms A.

The job rule set is a bundle of a plurality of job rules. The job rule set is used in the case where data in forms of a plurality of types are to be processed in a job. The information processing apparatus 20 discriminates what job rule the type of forms identified in a pre-process of the OCR process is suited to, and processes forms of each type on the basis of the discriminated job rule. The job rule set in the example illustrated in FIG. 3 represents definitions and rules of processes for the forms A of the type A and forms B of a type B. In this case, one job includes two types of forms to be processed, and includes processes for the forms A and processes for the forms B. Processing of forms according to a job rule for the forms A and processing of forms according to a job rule for the forms B are each referred to as a “sub job”.

The job rules and the job rule set are set in the process of (1) work design and operation verification in the OCR process of the form system 10 according to the present exemplary embodiment. The job rules and the job rule set may be determined in advance, or may be set as desired by the user. A plurality of job rules may be set, and a plurality of job rule sets may be set.

Next, output display of the form system 10 according to the present exemplary embodiment will be described. The output display described below may be output to the client terminal 40 etc. in the processes of (3) data reading, (4) form discrimination confirmation and correction, (5) reading result confirmation and correction, (6) work check, and (7) data output discussed above.

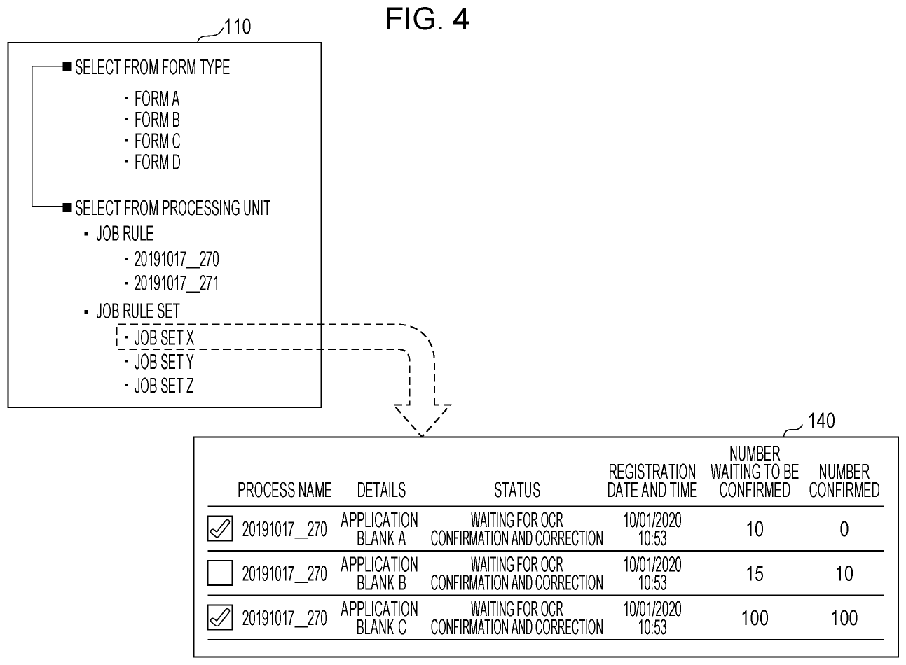

FIG. 4 illustrates an example of output display of the form system 10 according to the present exemplary embodiment. In the form system 10 according to the present exemplary embodiment, as illustrated in a select display screen 110 in FIG. 4, switching may be made between a mode in which data in forms to be processed are displayed for each type of the forms and a mode in which the data in the forms are displayed for each processing unit by which the data in the forms should be processed. Specifically, in the form system 10 according to the present exemplary embodiment, the user may select, on the select display screen 110 in FIG. 4, whether to display a list in which a plurality of the data in the forms are arranged for each type of the forms or for each processing unit for the data in the forms. The form system 10 according to the present exemplary embodiment displays the data in the forms to be processed in one of a first mode, in which the data in the forms are displayed on the screen for each type of the forms, and a second mode, in which the data in the forms are displayed on the screen for each processing unit, switchably in accordance with a request from the user.

In the form system 10 according to the present exemplary embodiment, the “form” is a general term for standard documents that are used enter and print information that is necessary for work or transactions such as ledgers, slips, and application blanks. The type of the forms indicates the type of the documents such as a ledger, a slip, and an application blank. On the select display screen 110 in FIG. 4, the type of a form is indicated as abbreviated such as form A and form B. The processing unit of data in the forms indicates the unit by which data input to the forms are to be processed, and may specifically be a job rule or a job rule set. The job rule prescribes a process for data in forms of a single type. The job rule set is a rule set which is a combination of job rules, and prescribes processes for data in forms for each of a plurality of types of the forms. For example, in the case where it is seen that data input in the process of data input include only data in forms of a single type, a job rule corresponding to the relevant type may be set for the data in the forms. However, a job rule set may also be set even in the case where it is seen that data input in the process of data input include only data in forms of a single type.

The select display screen 110 in FIG. 4 allows selecting whether to display data in forms to be processed for each type of the forms or to display the data in the forms for each processing unit. The select display screen 110 in FIG. 4 roughly allows selecting whether to display data in forms for each type of the forms or to display the data in the forms for each processing unit. When either option is selected, a list of forms is displayed for each type of the forms or for each processing unit, as in a form display list 140. A specific type may be selectable from among a plurality of types of forms on the select display screen 110 in FIG. 4. In this case, the list of forms is narrowed to the selected specific type of forms, and displayed in the form display list 140. Similarly, a specific job rule and a specific job set may be selectable from among a plurality of job rules and a plurality of job sets, respectively, on the select display screen 110 in FIG. 4. In this case, a list of data in forms is displayed in the form display list 140 for each selected specific job rule and job set.

In the example of the form display list 140 in FIG. 4, data in forms are displayed in the second mode in which the data in the forms are displayed for each processing unit. When a specific “job rule set X” is selected from a plurality of “job rule sets” as the processing unit on the select display screen 110, the screen transitions to the example of the form display list 140 illustrated in FIG. 2. In the example of the form display list 140, job rules included in the same job rule set X are treated as a group, and a list of data in the forms is displayed for each job rule set X. For example, a list of forms (application blank A, application blank B, and application blank C) to be processed under a process name “20191017_270” as the name of a job to be executed for the job rule set X is displayed as a group.

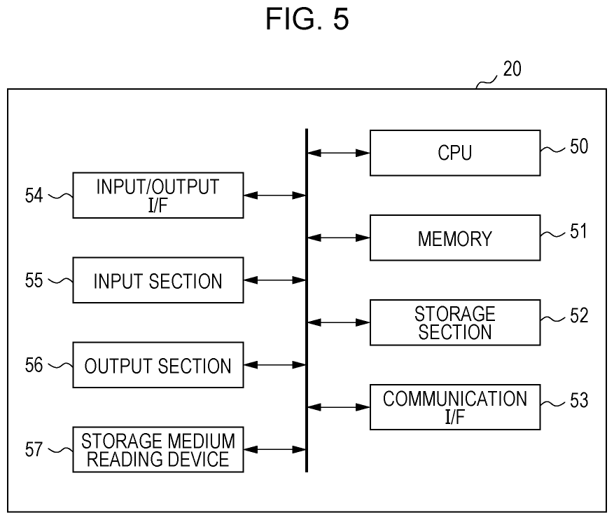

Next, the hardware configuration of the information processing apparatus 20 according to the present exemplary embodiment will be described. FIG. 5 is a block diagram illustrating the hardware configuration of the information processing apparatus 20 according to the present exemplary embodiment.

As illustrated in FIG. 5, the information processing apparatus 20 includes a central processing unit (CPU) 50, a memory 51, a storage section 52, a communication interface (I/F) 53, an input/output interface (I/F) 54, an input section 55, an output section 56, and a storage medium reading device 57.

The CPU 50 is a central processing unit, and executes various programs and controls various components. That is, the CPU 50 reads programs from the storage section 52, and executes the programs using the memory 51 as a work area. The CPU 50 controls the various components and performs various computation processes in accordance with the programs stored in the storage section 52.

The memory 51 is constituted from a random access memory (RAM), and serves as a work area to temporarily store programs and data. The storage section 52 is constituted as a ROM, an HDD, a solid state drive (SSD), etc., and stores various programs including an operating system and various data.

The communication interface 53 is an interface for communication with a difference device, and uses a standard such as Ethernet (registered trademark), fiber-optic data distribution interface (FDDI), and Wi-Fi (registered trademark), for example.

The input/output interface 54 is an interface that connects between the information processing apparatus 20 and an external device. In the present exemplary embodiment, the information processing apparatus 20 is connected to the input device 60 etc., which is external, via the input/output interface 54.

The input section 55 is a component for various types of input such as a keyboard or a mouse, for example. The output section 56 is a component that outputs the form display list 140 to the client terminal 40 etc., for example.

The storage medium reading device 57 reads data stored in various types of storage media such as a compact disk read only memory (CD-ROM), a digital versatile disk read only memory (DVD-ROM), a Blu-ray disc, and a universal serial bus (USB) memory, writes data into the storage media, etc.

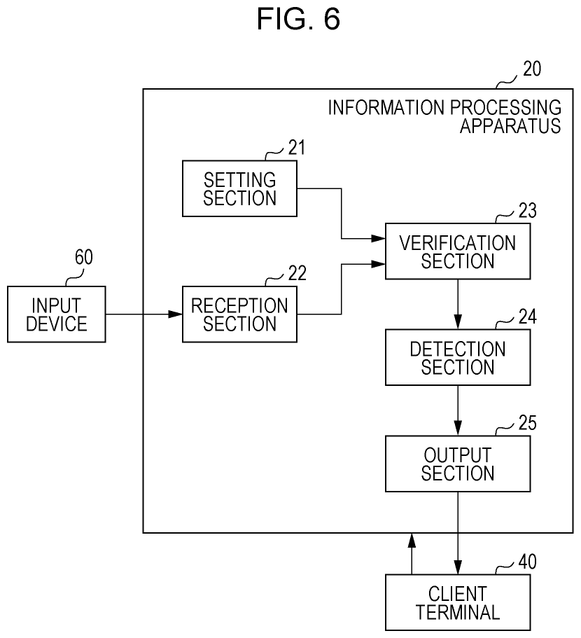

Next, the functional configuration of the information processing apparatus 20 according to the present exemplary embodiment will be described. FIG. 6 is a block diagram illustrating the functional configuration of the information processing apparatus 20.

As illustrated in FIG. 6, the information processing apparatus 20 includes, as functional components, a setting section 21, a reception section 22, a verification section 23, a detection section 24, and an output section 25.

The setting section 21 performs the process of (1) work design and operation verification in the OCR process discussed above, and sets job rules including reading definition setting, output setting, and work check setting. The setting section 21 further sets a job rule set which is a bundle of a plurality of job rules.

The reception section 22 performs the processes of (2) data input and (3) data reading in the OCR process discussed above. Specifically, the reception section 22 receives input of image data from the input device 60, and reads information in image data in a job to be executed using a job rule for the job selected by the user from among the job rules.

The verification section 23 performs the processes of (4) form discrimination confirmation and correction and (5) reading result confirmation and correction in the OCR process discussed above. The result of form discrimination and the result of reading of characters and symbols within the reading range are displayed, and a confirmation and a correction of the form discrimination by the user and a confirmation and a correction of the reading result are received.

The detection section 24 performs the process of (6) work check in the OCR process discussed above. An error in the foregoing processes is detected using work check setting included in a job rule for the job selected by the user from among the job rules.

The output section 25 performs the process of (7) data output in the OCR process discussed above. Output data are prepared using output setting included in a job rule for the job selected by the user from among the job rules, and the prepared output data are output to an output destination determined in advance such as the client terminal 40.

The output section 25 displays data in forms to be processed switchably in one of the first mode, in which the data in the forms are displayed for each type of the forms, and the second mode, in which the data in the forms are displayed for each processing unit.

The output section 25 displays a list in which a plurality of data in forms are arranged switchably in accordance with selection of one of the first mode and the second mode.

In the case where the first mode is selected, the output section 25 displays data in forms, which are arranged for each type of the forms in a list, in correlation with the processing unit to which the data in the forms belong.

In the case where the second mode is selected, the output section 25 displays data in forms, which are arranged for each processing unit in a list, in correlation with the type of the forms which is indicated by the data in the forms.

In the case where the second mode is selected, the output section 25 displays, in a list, a group of data in a single or a plurality of forms to be processed by one processing unit in such a manner as to be distinguishable from a group of data in a single or a plurality of forms to be processed by a different processing unit.

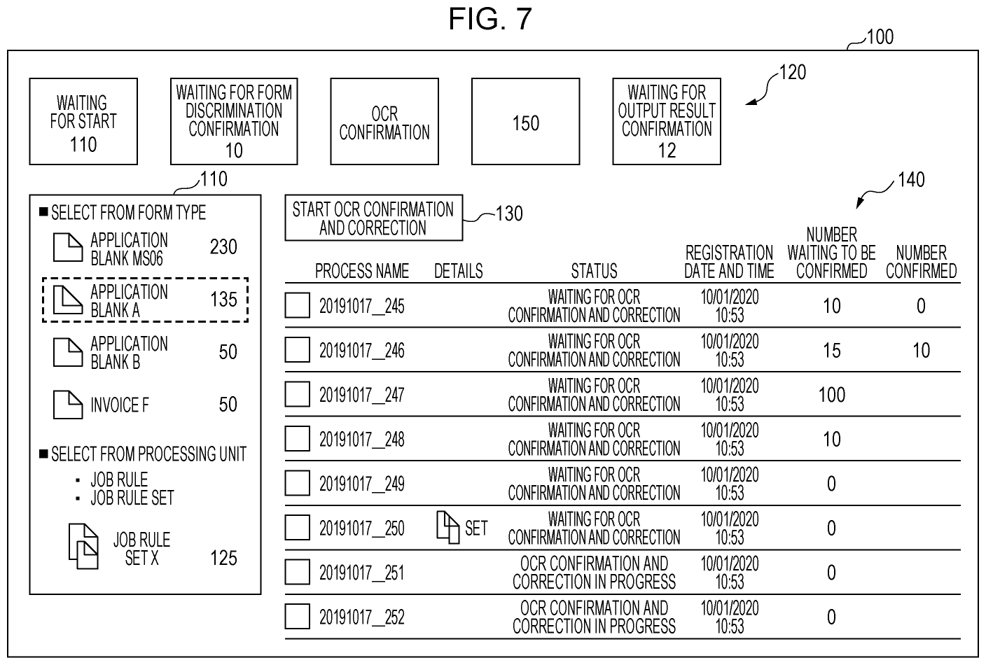

FIG. 7 illustrates a narrowing result display screen 100 as an example of a display screen output from the output section 25. The drawing illustrates a screen for the first mode that displays data in forms to be processed for each type of the forms. A status 120 displayed in the upper part of FIG. 7 indicates the processing status. The status 120 clearly indicates to the user what processes are being performed as a whole, among the processes (1) to (8) in the OCR process discussed above. The numbers indicated below the items indicate the number of forms to be processed. For example, the example of the status 120 in FIG. 7 indicates that there exist 110 forms in the processing status of “waiting for start” and 10 forms in the processing status of “waiting for form discrimination confirmation”.

A select display screen 110 in FIG. 7 is a select display screen that allows the user to switch between the first mode, in which the data in the forms to be processed are displayed for each type of the forms, and the second mode, in which the data in the forms are displayed for each processing unit, in accordance with selection by the user. The select display screen 110 in FIG. 7 achieves a rearrangement function of rearranging data in forms to be processed or a filter function of displaying narrowed data in forms to be processed. As illustrated in the select display screen 110 in FIG. 7, the information processing apparatus 20 according to the exemplary embodiment of the present disclosure receives selection of “form type” or “processing unit” from the user when displaying data in forms to be processed.

An execution button 130 in FIG. 7 is a button for executing a job selected by the user. Specifically, the execution button 130 is a button for executing a job on data in forms with a check mark given in the corresponding check box in the form display list 140 to be discussed later. More specifically, in the example illustrated in FIG. 7, data in forms associated with a job with a process name “20191017_245” have a status “waiting for OCR confirmation and correction”. When the execution button 130 is depressed, the process of (5) reading result confirmation and correction in the OCR process is executed by the verification section 23.

The form display list 140 in FIG. 7 displays data in forms as arranged for each type of the forms or for each processing unit for the data in the forms in accordance with selection made on the select display screen 110. For example, in the case where the application blank A is selected on the select display screen 110, the form display list 140 displays data in forms as arranged and narrowed to the application blank A.

In the case of FIG. 7, the user selects the “application blank A” in the “form type” on the select display screen 110, and therefore display in the example in FIG. 7 is made in the first mode. Data displayed in the form display list 140 in FIG. 7 are obtained by dividing, for each processing unit, data that have a job rule to process the application blank A to be processed. The form display list 140 includes, as examples of the other display items, “process name”, “details”, “status”, “registration date and time”, “number waiting to be confirmed”, and “number confirmed”. The “process name” is a name that indicates a sequence of processes to be performed on form data. Examples of the process name in FIG. 7 include “20191017_245”.

The “details” as a display item in the form display list 140 indicates whether the data in the forms are processed using a single job rule or a job rule set. In the example in FIG. 7, “set” is indicated in the “details” at a side of the process name “20191017_250”. This indicates that the form data included in the job “20191017_250” is processed using a job rule set. In other words, it is indicated that the job “20191017_250” includes a job rule set as a processing unit for processing data in a plurality of types of forms. In this manner, in the case where display for each type of the forms is selected, display of the data in the forms includes a processing unit to which the data in the forms belong.

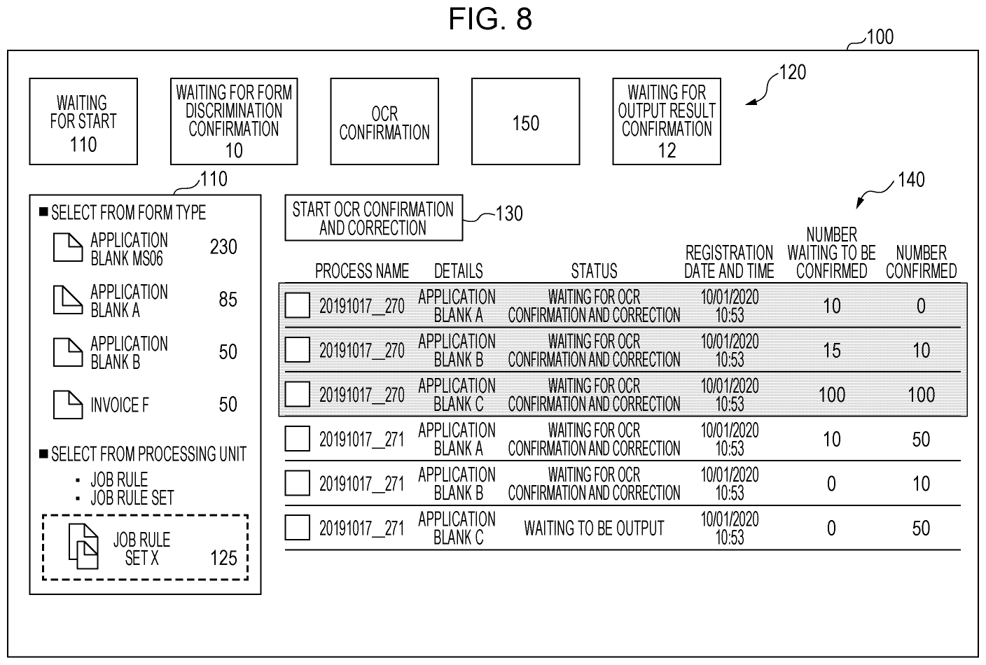

The content displayed in the “details” will be discussed later in the description of FIG. 8. Regarding the other display items in the form display list 140, the “status” indicates the processing status of the data in the forms to be processed being displayed. The “registration date and time” indicates the date and time when the data in the forms to be processed are registered. The “number waiting to be confirmed” and the “number confirmed” indicate the respective numbers of such forms represented in numbers.

FIG. 8 illustrates a display example of a screen for the second mode that displays data in forms for each processing unit. In FIG. 8, the user selects a “job rule set X” as a “job rule set” in the “processing unit” on the select display screen 110 which is displayed in the narrowing result display screen 100. Data in forms to be processed narrowed on the select display screen 110 are displayed in the form display list 140.

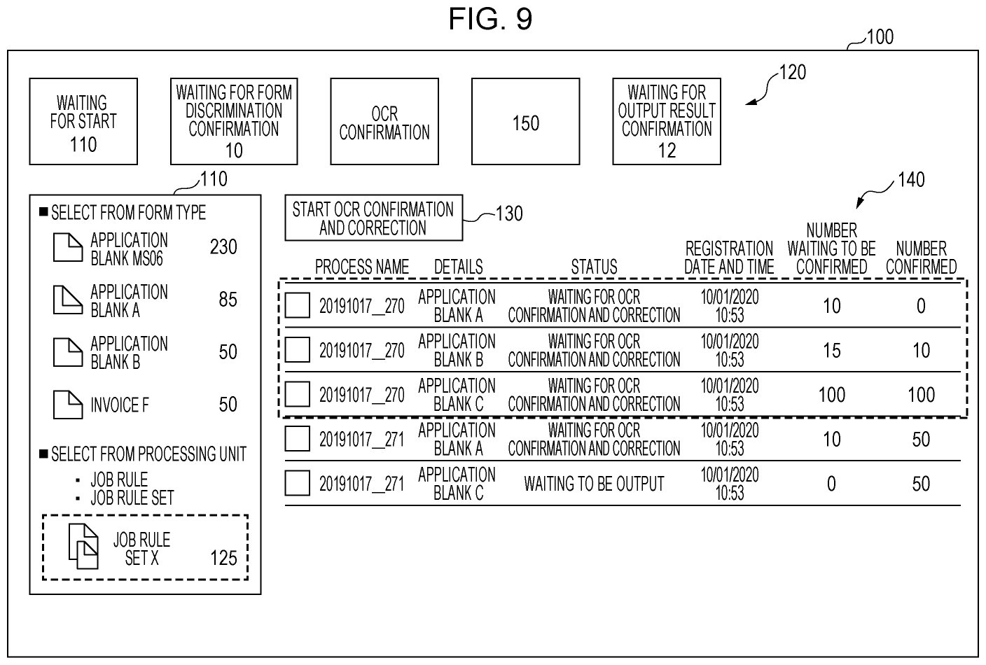

In the case where data in forms to be processed using a job rule set as the processing unit are displayed in a list, a plurality of data in forms with the same process name are displayed in the form display list 140. Jobs including job rule sets have a job rule set for each type of the forms to be processed. Therefore, data in forms to be processed are also displayed as arranged separately in accordance with the type of the forms. In this manner, some jobs including data in forms separated in accordance with the type of the forms and a job rule for data in the corresponding form from a job rule set are referred to as “sub jobs”. For example, in the form display list in FIG. 8, data in three forms are displayed in a box colored in gray. The data in the three forms are obtained by dividing data in forms included in one job into an application blank A, an application blank B, and an application blank C. Data in a form that represents the application blank A and a job rule for processing the application blank A constitute a sub job. In the form display list in FIG. 9, data in forms included in sub jobs are displayed as a list. It is also considered that sub jobs are displayed as a list in the form display list.

FIG. 9 illustrates another display example of a screen for the second mode that displays data in forms for each processing unit. FIG. 9 is different from FIG. 8 in that only sub jobs related to the application blank A and the application blank C are displayed for a process name “20191017_271”, and that a sub job related to the application blank B is not displayed. Even for a job that has a job rule set, a sub job is not prepared for a form of a type for which data are not input or taken in when data in forms to be processed are divided for each processing unit. Therefore, a sub job may not be displayed as illustrated in FIG. 9, even if there is actually a job rule for the application blank B.

In the case where the second mode in which data are displayed for each processing unit is selected on the select display screen 110, the form display list 140 may display data in forms grouped by the processing unit in such a manner as to be distinguishable from other data in forms. For example, in order to clearly indicate the range of a group of sub jobs with a process name “20191017_270”, the color of lines in which data in forms are displayed may be different from the color of lines in which data in forms for a different processing unit as illustrated in FIG. 8, or a group of data in forms for a target sub job may be surrounded in a box as illustrated in FIG. 9. Besides the above methods, data in forms grouped by the processing unit may be displayed in such a manner as to be distinguishable from data in forms for a different processing unit.

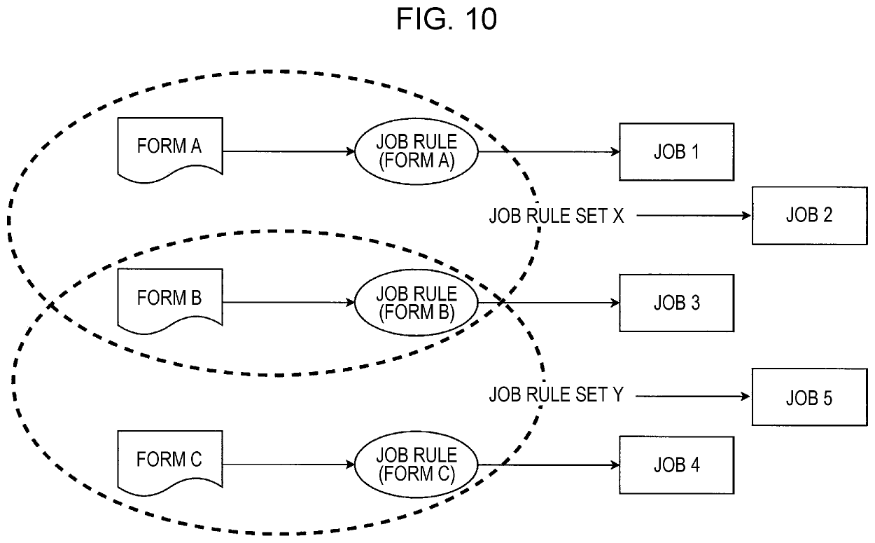

FIG. 10 illustrates the relationship among the forms, the job rules, the job rule sets, and the jobs. As discussed above, the “job rule” refers to definitions and rules for executing a process for forms of a single type. Therefore, a single job rule is set for a single form. In FIG. 10, respective job rules are set for the form A, the form B, and the form C. Meanwhile, the “job rule set” is a bundle of a plurality of job rules. In the example in FIG. 10, a job rule set X is a processing unit that includes the job rule for the form A and the job rule for the form B. In addition, a job rule set Y is a processing unit that includes the job rule for the form B and the job rule for the form C. In FIG. 10, the job rule for the form A is set as a job 1, the job rule set X is set as a job 2, the job rule for the form B is set as a job 3, the job rule set Y is set as a job 5, and the job rule for the form C is set as a job 4.

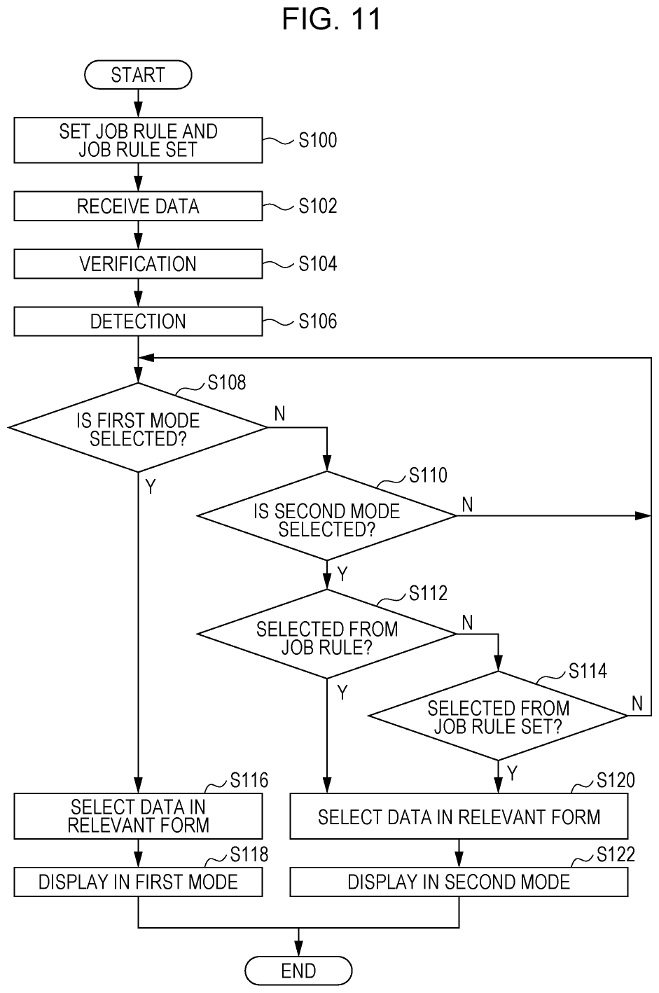

Next, the function of the information processing apparatus 20 according to the present exemplary embodiment will be described. FIG. 11 is a flowchart illustrating a process performed by the information processing apparatus 20 according to the present exemplary embodiment. The process performed by the information processing apparatus 20 according to the present exemplary embodiment is executed when the CPU 40 reads an information processing program stored in the storage section 52 etc.

In step S100, the CPU 40 as the setting section 21 sets a job rule and a job rule set in advance. The CPU 40 performs the process of (1) work design and operation verification in the OCR process discussed above. The CPU 40 may receive setting of a job rule and a job rule set made by the user.

In step S102, the CPU 40 as the reception section 22 receives image data etc. to be processed via the input device 14, and performs the processes of (2) data input and (3) data reading in the OCR process discussed above.

In step S104, the CPU 40 as the verification section 23 performs verification processes, such as (4) form discrimination confirmation and correction and (5) reading result confirmation and correction in the OCR process discussed above, on the image data received by the reception section 22 in step S102.

In step S106, the CPU 40 as the detection section 24 performs the process of (6) work check in the OCR process discussed above. Specifically, a process error for a form in the foregoing processes is detected in accordance with a job rule or a job rule set for a job and selected as desired by the user, from among all the job rules and the job rule sets set by the setting section 21 in step S100.

In step S108, the CPU 40 as the output section 25 determines whether or not selection for outputting a display screen in the first mode is received. In the case where the user selects the first mode, that is, “select from form type”, on the select display screen 110, the process proceeds to step S116. In the case where the user does not select “select from form type”, on the other hand, the process proceeds to step S110.

In step S110, the CPU 40 as the output section 25 determines whether or not selection for outputting a display screen in the second mode is received. In the case where the user selects the second mode, that is, “select from processing unit”, on the select display screen 110, the process proceeds to step S112. In the case where the user does not select “select from processing unit”, on the other hand, the process returns to step S108, and receives selection of display by the user again on the select display screen 110.

In step S112, the CPU 40 as the output section 25 receives selection as to which of a job rule and a job rule set the display screen is to be output on the basis of, and determines whether or not a job rule is selected. In the case where the user selects “select from job rule” on the select display screen 110, the process proceeds to step S120. In the case where the user does not select “select from job rule”, on the other hand, the process proceeds to step S114.

In step S114, the CPU 40 as the output section 25 receives selection as to which of a job rule and a job rule set the display screen is to be output on the basis of, and determines whether or not a job rule set is selected. In the case where the user selects “select from job rule set” on the select display screen 110, the process proceeds to step S120. In the case where the user does not select “select from job rule set”, on the other hand, the process returns to step S108, and receives selection of display by the user again on the select display screen 110.

In step S116, the CPU 40 as the output section 25 selects only data in forms narrowed for each type of the forms specified by the user from among all the recorded jobs.

In step S118, the CPU 40 as the output section 25 outputs a display screen in which the job selected in step S116 is displayed in the first mode.

In step S120, the CPU 40 as the output section 25 selects only data in forms narrowed using a filter for a job rule or a job rule set specified by the user from among all the recorded jobs.

In step S122, the CPU 40 as the output section 25 outputs a display screen in which the job selected in step S120 is displayed in the second mode.

In the present exemplary embodiment, the information processing program is installed in the storage section 42. However, the present disclosure is not limited thereto. The information processing program according to the present exemplary embodiment may be provided as stored in a computer-readable storage medium. For example, the information processing program according to the present exemplary embodiment may be provided as stored in an optical disk such as a CD-ROM and a DVD-ROM, or as stored in a semiconductor memory such as a USB memory and a memory card. Alternatively, the information processing program according to the present exemplary embodiment may be acquired from an external device via a communication line connected to the communication interface 43.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
display data in forms to be processed, switchably in one of a first mode, in which the data in the forms are displayed for each type of the forms, and a second mode, in which the data in the forms are displayed for each processing unit by which the data in the forms are to be processed.

2. The information processing apparatus according to claim 1,
wherein the processor is configured to display a list in which a plurality of the data in the forms are arranged switchably in accordance with a selected one of the first mode and the second mode.

3. The information processing apparatus according to claim 2,
wherein the processor is configured to display, in a case where the first mode is selected, the data in the forms, which are arranged for each type of the forms in the list, in correlation with the processing unit to which the data in the forms belong.

4. The information processing apparatus according to claim 2,
wherein the processor is configured to display, in a case where the second mode is selected, the data in the forms, which are arranged for each processing unit in the list, in correlation with the type of the forms which is indicated by the data in the forms.

5. The information processing apparatus according to claim 3,
wherein the processor is configured to display, in a case where the second mode is selected, the data in the forms, which are arranged for each processing unit in the list, in correlation with the type of the forms which is indicated by the data in the forms.

6. The information processing apparatus according to claim 2,
wherein the processor is configured to display in the list, in a case where the second mode is selected, a group of data in a single or a plurality of forms to be processed in one processing unit in such a manner as to be distinguishable from a group of data in a single or a plurality of forms to be processed in a different processing unit.

7. The information processing apparatus according to claim 3,
wherein the processor is configured to display in the list, in a case where the second mode is selected, a group of data in a single or a plurality of forms to be processed in one processing unit in such a manner as to be distinguishable from a group of data in a single or a plurality of forms to be processed in a different processing unit.

8. The information processing apparatus according to claim 4,
wherein the processor is configured to display in the list, in a case where the second mode is selected, a group of data in a single or a plurality of forms to be processed in one processing unit in such a manner as to be distinguishable from a group of data in a single or a plurality of forms to be processed in a different processing unit.

9. The information processing apparatus according to claim 5,
wherein the processor is configured to display in the list, in a case where the second mode is selected, a group of data in a single or a plurality of forms to be processed in one processing unit in such a manner as to be distinguishable from a group of data in a single or a plurality of forms to be processed in a different processing unit.

10. A non-transitory computer readable medium storing an information processing program causing a computer to execute a process comprising:
displaying data in forms to be processed, switchably in one of a first mode, in which the data in the forms are displayed for each type of the forms, and a second mode, in which the data in the forms are displayed for each processing unit by which the data in the forms are to be processed.

11. An information processing apparatus comprising:
means for displaying data in forms to be processed, switchably in one of a first mode, in which the data in the forms are displayed for each type of the forms, and a second mode, in which the data in the forms are displayed for each processing unit by which the data in the forms are to be processed.
